(19) United States
(12) Patent Application Publication
(10) Pub. No.: US 2010/0092348 A1
(43) Pub. Date: Apr. 15, 2010

(54) RELATIVELY THICK-WALLED VACUUM-RESISTANT AND PRESSURE-RESISTANT VESSEL

(75) Inventors: Ernest Totino, Sainte Ruffine (FR); Emmanuel Kelbert, Nancy (FR); Thierry Nodari, Laxou (FR)

Correspondence Address: DENNISON, SCHULTZ & MACDONALD, 1727 KING STREET, SUITE 105, ALEXANDRIA, VA, 22314, US

(73) Assignee: CARBONE LORRAINE EQUIPEMENTS GENIE CHIMIQUE (SASU), Pagny-sur-Moselle (FR)

(21) Appl. No.: 12/529,814

(22) PCT Filed: Mar. 5, 2008
(86) PCT No.: PCT/FR08/00287

§ 371 Date: Sep. 15, 2009

(30) Foreign Application Priority Data
Mar. 5, 2007 (FR) 07 01585

(51) Int. Cl. B01J 19/02; G21C 13/087; B23P 11/00

(52) U.S. Cl. 422/159; 422/242; 422/241; 29/428

(57) ABSTRACT

The vessel of the invention includes a side wall and an end wall, and is characterized in that the end wall is a domed end wall, of thickness E_{I} including an inner layer C_{I} providing corrosion resistance and an outer layer CE of thickness EE at least equal to the thickness E_{I} of the inner layer C_{I}. The inner and outer layers are rigidly joined by a first assembly device. Inner layer C_{I} is formed from a multilayer material including an internal layer C_{I} for providing corrosion resistance and an external layer C_{IS}, the internal C_{IC} and the external C_{IS} layers being rigidly joined by a second assembly device. The invention enables inexpensive manufacture of large vessels.

### FIELD OF THE INVENTION

The invention relates to the field of vessels that form confined spaces inside of which take place chemical, physical or physical-chemical transformations under pressure in the case of reactors, or wherein are stored products under pressure.

Such vessels form in particular reactors used in the chemical, pharmaceutical, oil industry or in nuclear power plants.

Such vessels can also require a resistance to a vacuum, taking into account the fact that they can be subjected to an at least partial vacuum whether during a step of said transformations, or, for example, during a step of maintenance of the vessels.

### PRIOR ART

Generally, high-pressure resistant vessels or metal reactors are already known. These reactors typically include a cylindrical side wall and domed end walls.

The domed end walls and the side wall are assembled either using mechanical means, for example using clamps, or by welding.

Generally, these vessels and reactors must also have a high resistance to any type of corrosion in light in particular of the extreme danger that leaks have in a vessel under pressure, i.e. typically under pressure greater than 50 bar or 5 MPa.

The applicant has already developed methods of manufacturing multilayer material plates able to resist corrosion, as described for example in French patent no. 2 883 006 and in international applications WO02/051576 and WO 03/097230. The applicant has formed vessels or elements of chemical devices by forming these metal multilayer material plates by butt welding them.

Advantageously, in light in particular of the cost of corrosion-resistant materials, such as tantalum, these methods of manufacturing provide for the assembly of a thin corrosion-resistant metal coating, for example of a magnitude of 1 mm, on a support of much greater thickness, while, in a method of prior such as cladding by explosion (“explosion clad”), the thickness of the corrosion-resistant metal coating cannot be much less than 20 mm.

Moreover, French patent no. 1 198 743 discloses the manufacture of vessels under pressure comprising a ferritic steel envelope and an austenitic steel layer as corrosion-resistant metal, and the butt weld of such a multilayer composite material.

American patent U.S. Pat. No. 3,140,006 is also known which discloses a vessel under pressure intended for the storage of hydrogen, comprising an outer wall and an inner wall, said outer wall comprising a plurality of vents, said outer and inner walls not including a metallurgical bond in such a way that all of the hydrogen distributed through said inner wall can escape via said vents, said inner wall comprising two layers being formed by butt welding of these two layers. European patent no. 0 146 081 is also known which discloses a method for manufacturing a portion of a wall of a vessel intended to contain hydrogen under pressure. In this method, which discloses the manufacturing of a multilayer wall element, on a basic outer layer, of chromium steel, an inner layer of low-carbon steel is formed by welding, then, on this inner layer, a chromium and nickel base corrosion-resistant layer is formed by welding.

Japanese patent no. 56 017628 is also known which discloses a vessel under pressure comprising from the exterior to the interior:

a) an outer cylinder of carbon steel,

b) a multilayer component formed by a winding of a thin carbon steel sheet,

c) an inner cylinder comprising a carbon steel layer and a corrosion-resistant layer,

d) a corrosion-resistant coating forming a layer comprising weld zones with detection holes, on either side of the weld.

### Problems Set Forth

The multilayer material plates of prior art do not allow for the economical manufacturing of large-size elements of chemical engineering, with the constant race towards productivity that is always greater resulting in fact in a race towards means of production that are further gigantic.

Manufacturing chemical engineering devices such as vessels or reactors of large size resisting pressure and vacuum using large-size plates would create a major problem as this would require specific tools or devices to be perfected—in particular very high-power forming presses—in order to form the elements that comprise said vessel.

Moreover, another problem is to be able to manufacture different sizes of vessels, and in particular to have a generic means adapted to present and future changes, in particular in terms of productivity, since each epoch corresponds to a standard of productivity, with production equipment of a given size forming the standard of today having a strong risk of becoming obsolete tomorrow.

It is therefore important that the manufacturer of equipment, and here the manufacturer of large-size reactors or vessels intended to be vacuum-resistant as well as pressure-resistant, do not have to constantly change all of his means of production in order to adapt to the new requests of his customers.

Furthermore, the manufacturing of chemical engineering equipment under pressure generally requires many welds, some of which must be carried out in particularly difficult conditions, in particular when it entails butt welding multilayer materials such as has been experienced by the applicant, in particular when it entails welding relatively thin layers.

In addition, forming metal materials and the presence of relatively thick welds results in the requirement to proceed with heat post-treatments of the equipment, which is very costly in terms of investment as well as in terms of production costs, as these treatments are required in order to relieve of internal stress the materials formed in such a way as to comply with the requirements described in the manufacturing codes for chemical engineering equipment, such as the CODAP code in Europe or the ASME code in the USA.

Finally, the materials that are able to provide a resistance to corrosion, such as for example tantalum, being highly reactive when hot, the parts containing these materials must be vacuum heat-treated, which further increases the cost of such heat post-treatments.

### OBJECTS OF THE INVENTION

A first object of the invention is a large vessel able to resist pressure and vacuum, designed in such a way as to not require particular means to manufacture it, these vessels able to be formed in particular using conventional forming presses, which is of great interest for the manufacturer of such vessels.

Another object of the invention is constituted by a method of manufacture which makes it possible to limit the number of welds, and to avoid in particular the “difficult” welds of prior art, in particular to avoid the butt welds of multilayer materials.

Furthermore, this method makes it possible to limit, and even eliminate the heat post-treatments that are required with the methods of prior art in order to comply with the requirements of the construction codes, such as the CODAP or ASME codes.

More generally, the object of the invention is an element of forming for a chemical engineering device able to resist pressure and vacuum, whether entailing a reactor end wall, as developed in more detail in the description, or a wall of a vessel or any other relatively large-size element of a chemical engineering device.

### DESCRIPTION OF THE INVENTION

According to the invention, the vessel, typically a reactor intended for implementing nuclear or chemical reactions, forming a device for storing or transforming products able to resist pressure and vacuum, includes a side wall typically cylindrical of diameter D at least equal to 1 m, and an end wall, typically likewise diameter D, assembled to said side wall, said side wall and said end wall being typically of metal.

It is characterised in that:

a) said end wall of said vessel is a domed end wall,

b) said domed end wall forms a multilayer component of thickness E comprising:

b1) a so called inner layer C_{I} providing a chemical inertness of said domed end wall with regards to said products, and typically a resistance to corrosion with regards to said products,

b2) and a so-called outer layer C_{E} of thickness E_{E} at least equal to the thickness E_{I} of said inner layer C_{I}, in such a way that the so-called outer layer C_{E} provides the major part of the mechanical resistance of said multilayer component of total thickness E equal to E_{E}+E_{I}, and its resistance to pressure,

c) said inner C_{I} and outer C_{E} layers are more preferably rigidly joined by a so-called first assembly means, in such a way that said inner layer C_{I} cannot separate from the so-called outer layer C_{E} in particular when said vessel is placed in a vacuum,

d) said inner layer C_{I} is a multilayer inner layer C₁′ formed of a multilayer material comprising at least one so-called internal layer C_{IC} forming an inner coating of thickness E_{IC} in a so-called first material M_{IC} able to provide said resistance to corrosion, and a so-called external layer C_{IS} of thickness E_{IS} in a so-called second material M_{IS} forming a support for said internal layer C_{IC}, said internal C_{IC} and external C_{IS} layers being rigidly joined by a so-called second assembly means, in such a way that said internal C_{IC} and external C_{IS} layers cannot separate from one another in particular when said vessel is placed in a vacuum,

e) said vessel is devoid of butt welds of multilayer materials, in particular for said inner layer C_{I}.

The combination of means a) to e) according to the invention solves all of the problems set forth.

Indeed, it has allowed the applicant not only to manufacture a large vessel, but also to manufacture a complete range of vessels of various sizes, and this without having to change the conventional forming presses.

Furthermore, it makes it possible to limit the number of welds and to avoid in particular the butt welds of multilayer materials.

Finally, it offers to those skilled in the art means for avoiding to a large measure the costly post-treatments required to comply with the construction codes while still guaranteeing the safety of this chemical engineering equipment.

According to the invention, said inner C_{I} and outer C_{E} layers are more preferably rigidly joined by a so-called first assembly means, as there are cases wherein these inner and outer layers may not be rigidly joined in particular because said inner layer has in itself a sufficient resistance to vacuum, or yet because, in the conditions of standard use of said vessel, the vacuum is not a high vacuum.

### DESCRIPTION OF THE FIGURES

FIGS. 1a to 6f relate to the invention.

FIG. 1a is an axial cross section of a domed end wall (3′) of a reactor (1′). In this figure, a multilayer side wall (2, 2′) according to the invention is shown in dotted lines.

FIG. 1b is a underneath view of said domed end wall (3′) or of said outer shaping component (5a) forming the so-called outer layer C_{E} (5) of said domed end wall (3′).

FIGS. 2a to 2c relate to said inner part (6′) serving to form said inner layer C_{I} (4) of the shaping component (3).

FIG. 2a is an axial cross section showing the forming of the inner metal strip (6) using a device for forming (8) so as to form said inner shaping component (4a).

FIG. 2b is an axial cross section of the inner shaping component (4a) obtained as such by forming and cutting of the edge.

FIG. 2c is an enlarged view of the right portion of FIG. 2b circled in dotted lines.

FIG. 2d, analogous to FIG. 2c, shows the case where said inner layer (4) comprises an intermediary layer C_{II} (43) rigidly joining the internal C_{IC} and external C_{IS} layers.

FIGS. 3a to 3c relate to another mode of said outer shaping component (5a) serving to form so-called outer layer C_{E} (5) of the domed end wall (3′).

FIG. 3a is an underneath view analogous to FIG. 1b.

FIG. 3b is an axial cross-section view according to the vertical plane A-A of FIG. 3a according to an axial direction (10) of said vessel (1).

FIG. 3c is a schematic representation of the forming of a plane blank (70) cut in an outer strip (7) leading, by the implementation of a forming press (8), not shown and symbolised by an arrow, to an element of forming (51).

FIGS. 4a to 4f′ show different steps and different modes of the method of manufacturing according to the invention.

FIG. 4a shows a perspective view of a coil of material in strips of width L: inner strip (6) or first strip (60) or second strip (61) or outer strip (7), when its thickness allows a coil to be formed.

FIGS. 4b to 4f show the case where in the diameter D sought is close to less than the width L of the strip, while FIGS. 4b′ to 4f′ show the case where the strips (60, 61, 7) have been butt tailored in order to double the width of the strip and obtain a strip (62, 63, 7a) composed of two portions (620, 630, 71) rigidly joined by a weld (621, 631, 72).

FIGS. 4b and 4b′ are top views of blanks cut in a strip: blank (6, 60′, 61′, 7′) cut in the strip (6, 60, 61, 7) in FIG. 4b, and blank (62′, 63′, 7a′) cut in the strip (62, 63, 7a).

FIGS. 4c to 4f′ are transversal cross sections in a vertical plane containing the axial direction (10).

FIGS. 4c and 4c′ relate to said first blank (60′) intended to form the layer C_{IC} of thickness E_{IC}.

FIGS. 4d and 4d′ relate to said second blank (61′) intended to form the layer C_{IS} of thickness E_{IS}.

FIGS. 4e and 4e′ relate to said outer blank (7′) intended to form the outer layer, C_{E} of thickness E_{E}.

FIGS. 4f and 4f′ show the outer shaping component (5a) formed by forming outer blanks (7′, 7′a) in FIGS. 4e and 4e′, using a forming press (8).

FIGS. 5a to 5e show a mode of manufacturing of said inner shaping component (4a) in the case wherein strips (62, 63) must be used composed of portions (620, 630) welded together by a weld seam (621, 631) as shown in FIGS. 4b′ to 4d′.

FIGS. 5a to 5c relate to a blank (6′) wherein the blanks (62, 63) have been directed in such a way that the weld seams (621, 631) are orthogonal. FIG. 5a is a top view making it possible to view said first blank (62′) comprising 2 portions (620) welded by a weld seam (621).

FIG. 5b is a side view making it possible to view the end of the weld seam (621) of said first blank (62′), while FIG. 5c is a side view, directed at 90° in relation to FIG. 5b, making it possible to view the end of the weld seam (631) of said second blank (63′).

FIG. 5d is a cross-section view showing said shaping component (4a) obtained by forming of the blank (6′) in FIGS. 5a to 5c.

FIG. 5e is an enlarged view of the portion D surrounded by a circle of FIG. 5d.

FIGS. 6a to 6f are analogous cross-section views which show two modes of forming of said first assembly means (30) intended to rigidly join said inner (4) and outer (5) layers.

According to a first mode shown in FIGS. 6a to 6c, the so-called outer layer (5) is a layer composed of a plurality of elements (50) intended to be welded. FIG. 6a shows, before their welding, two elements (50) arranged on the inner layer (4), of which the edges (500) are across from therein.

FIG. 6b shows the first stage of welding (55) with formation of a first weld layer (550) that rigidly joins the inner layer (4) to the elements (50).

FIG. 6c shows, with the weld (55) completed, the portion of multilayer component (3″) obtained as such.

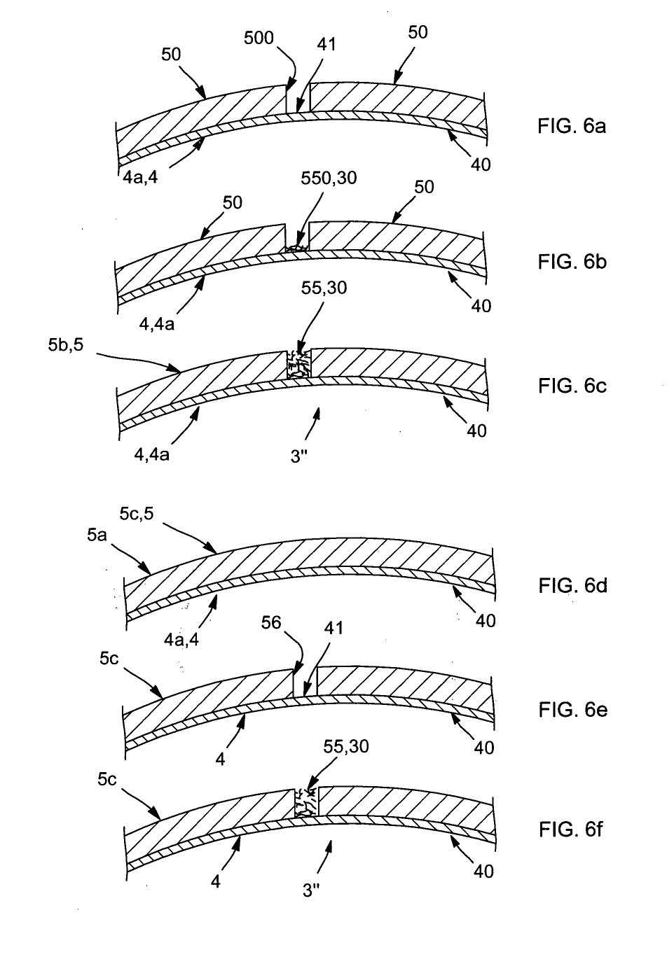

According to a second mode shown in FIGS. 6d to 6f, the outer shaping component (5a) is arranged in contact with the inner shaping component (4a), as shown in FIG. 6d, and provided with a certain number of bores (56) until the external layer (41), as shown in FIG. 6e, then this bore is filled with weld material, in such a way as to rigidly join together the inner (4) and outer (5) layers.

### DETAILED DESCRIPTION OF THE INVENTION

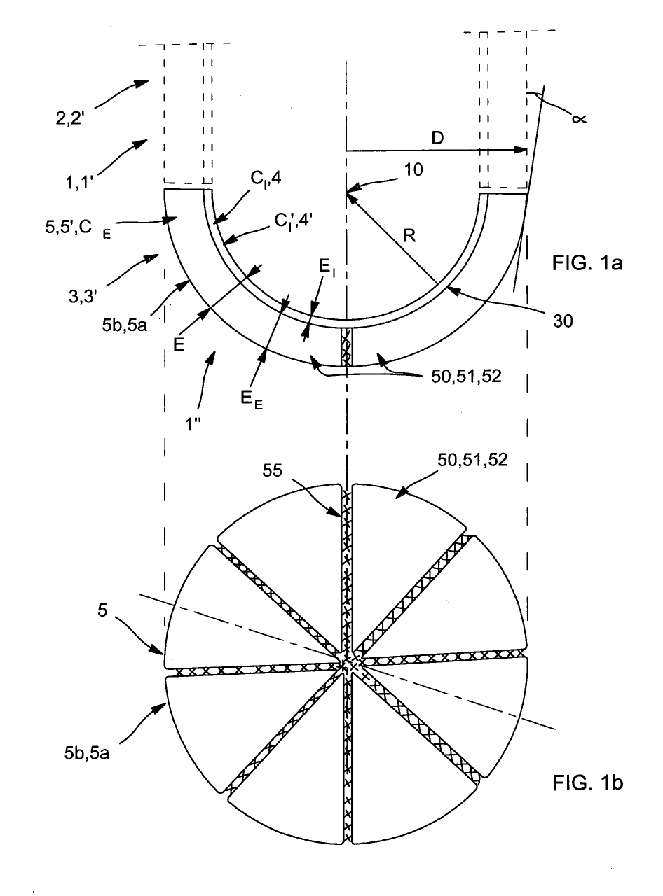

According to the invention, and as shown for example in FIG. 1a, the so-called outer layer C_{E} (5, 5′) can be an outer layer (5b) comprising a plurality of N elements (50) of thickness E_{E} rigidly joined together by a so-called outer butt weld (55), with N ranging typically from 2 to 16.

Advantageously, and as shown in FIG. 1b, said plurality of N elements (50) can be formed of N identical elements (52) rigidly joined together by said outer weld (55).

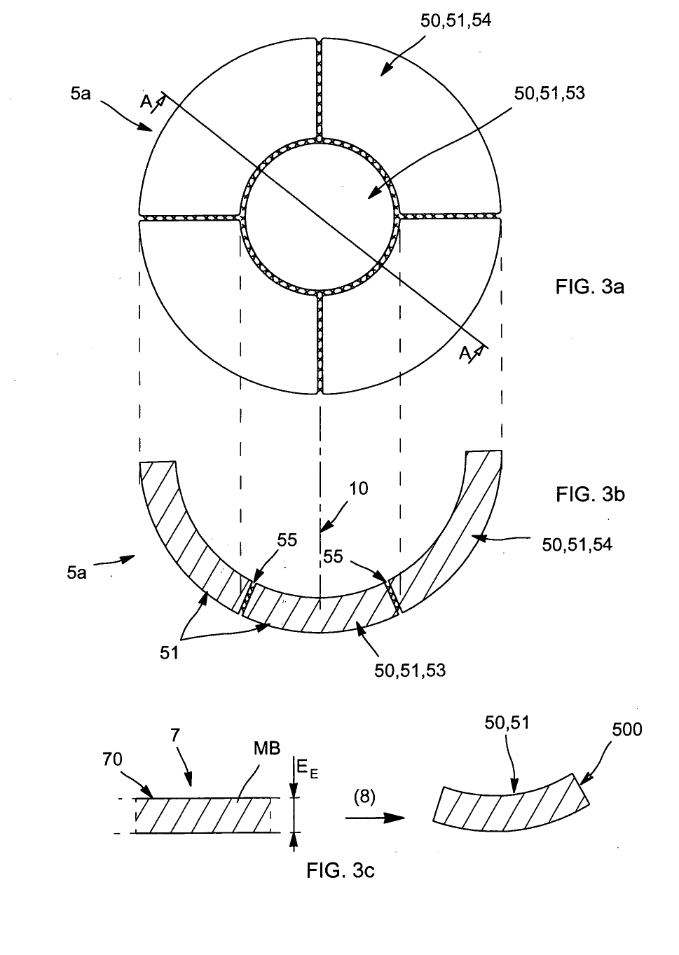

However, as shown in FIG. 3a, said plurality of N elements (50) can include a central element (53) and N−1 identical peripheral elements (54).

Generally, at least one portion of said N elements (50) can be elements of forming (51), typically formed elements formed by a forming press using a material in strips (7) of substantially the same thickness E_{E}.

Typically, the number N of elements (50) can be selected according to the thickness E_{E} of the so-called outer layer (5, 5′), the number N increasing with the thickness E_{E}, in such a way that said forming press can be selected from among the forming presses of power less than 1500 tonnes; these presses are typically “standard” commercially-available presses.

However, when said thickness E_{E} is not too high, and as shown in FIG. 6d, the so-called outer layer C_{E} (5, 5′) can be an outer layer (5c) including a single element forming a single-layer shaping component of thickness E_{E}.

According to the invention, the ratio of thicknesses E_{E}/E_{I} can range from 1 to 20 and more preferably from 2 to 10.

Said thickness E_{E} can range from 15 mm to 100 mm. Said thickness E_{I} can range from 4 mm to 15 mm, and more preferably from 5 mm to 10 mm.

Said internal layer C_{IC} (40) can have a thickness E_{IC} ranging typically from 0.4 mm to 4 mm.

The ratio of thicknesses E_{IS}/E_{IC} can range from 2 to 10.

According to the invention, said first material M_{IC} forming said internal layer C_{IC} (40) can be selected from among: tantalum or tantalum alloys, titanium, titanium alloys, zirconium, zirconium alloys, nickel-base alloys and stainless steels.

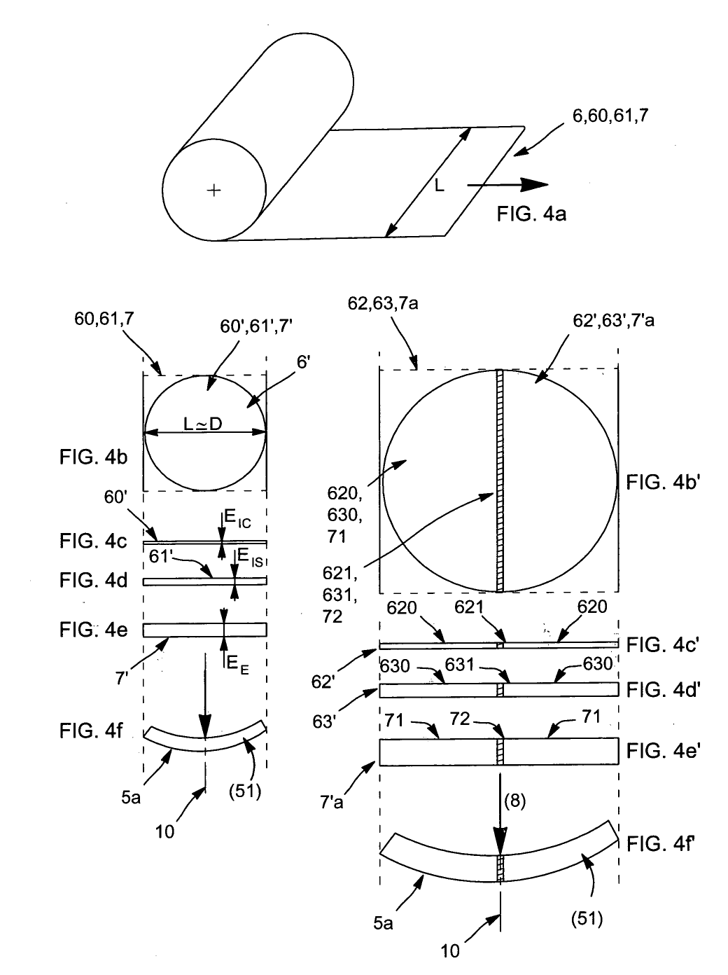

As shown in the FIGS. 3c, 4a, 4b, 4b′, 4e, 4e′, 4f and 4f′, the so-called outer layer C_{E} (5, 5′) can be formed using a so-called basic material M_{B}, in strips (7) of thickness substantially equal to E_{E}, said basic material M_{B} being typically selected from among steels or stainless steels.

Likewise, said second material M_{IS} forming said external layer (41) can be selected from steels or stainless steels.

As such, said second material M_{IS} forming said external layer (41) and said basic material M_{B} forming the so-called outer layer (5, 5′) can be more preferably identical.

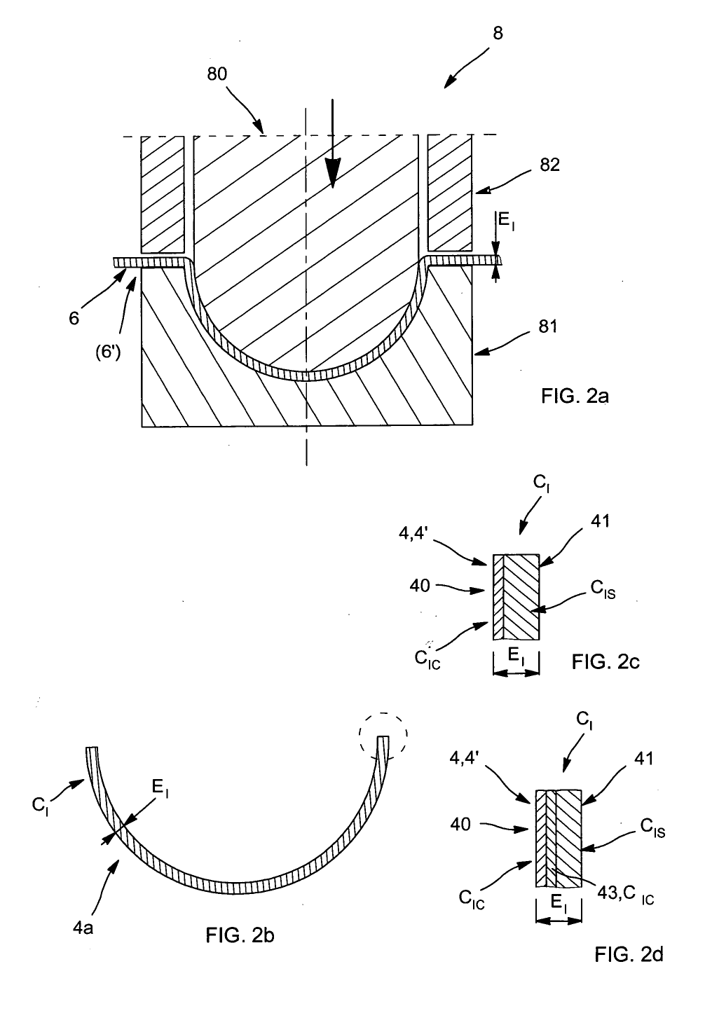

As shown in FIG. 2d, said multilayer inner layer C_{I}′ (4′) can include an intermediary layer C_{II} (43) rigidly joining said internal layer C_{IC} (40) to said external layer C_{IS} (41), said multilayer inner layer C_{I}′ (4′) forming as such a multilayer material shown symbolically by C_{IC}/C_{II}/C_{IS}, said internal layer C_{IC} (40) being intended to be in contact with said products, said external layer C_{IS} (41) being rigidly joined to the so-called outer layer C_{E} (5) thanks to said first assembly means (30).

Said intermediary layer C_{II} (43) can be, more preferably, a brazing layer (43′).

According to a mode of the invention, said internal C_{IC} (40) and external C_{IS} (41) layers can be co-laminated layers, in such a way as to form said second assembly means (42).

According to another mode of the invention, said internal C_{IC} (40) and external C_{IS} (41) layers can be plated or “cladded”, typically by explosion, in such a way as to form said second assembly means (42).

As shown in FIGS. 6a to 6f, said inner C_{I} (4, 4′) and outer C_{E} (5, 5′) layers can be assembled together by welding or by brazing, in such a way as to form said first assembly means (30).

As shown schematically in FIG. 1a, said side wall (2) can be a multilayer side wall (2′) comprising:

a) a so-called inner wall layer C_{IP} (20) similar to said inner layer C_{I} (4,4′) comprising said internal layer C_{IC} (40) in said first material M_{IC} providing said corrosion resistance, and said external layer C_{IS} (41) in said second material M_{IS} forming a support for said internal layer C_{IC} (40), and

b) a so-called outer wall layer C_{EP} (21) similar to the so-called outer layer C_{E} (5, 5′) in said basic material M_{B}, of thickness at least equal to the thickness of said inner wall layer C_{IP} (20), in such a way that said outer wall layer C_{EP} (21) provides the major part of the resistance or mechanical resistance of said side wall (2, 2′) to pressure to a vacuum.

More preferably, said end wall (3, 3′, 3″) and said side wall (2, 2′) can be connected by making an angle α less than 60°.

According to the invention, said domed end wall (3′) can be a tapered end wall or an end wall forming a spherical cover of radius of curvature R at least equal to 0.5 D.

According to a mode of the invention, and as shown in the figures, the so-called outer layer C_{E} (5) can be an outer layer C_{E}′ (5′) formed of a single-layer material having said thickness E_{E}.

However, according to another mode of the invention, the so-called outer layer C_{E} (5) is an outer layer C_{E}40 formed of a multilayer material having said thickness E_{E}.

Another object of the invention is a method for manufacturing an end wall (3, 3′, 3″) of said vessel (1) according to the invention.

In this method:

a) a so-called outer shaping component (5a) of diameter substantially equal to D is formed, having for example said radius of curvature R, and intended to form the so-called outer layer C_{E} (5, 5′) of said end wall (3, 3′, 3″), using a forming press (8) using a so-called outer strip (7), typically plane, of said basic material M_{B} and of thickness E_{E}, or of a blank (7′), typically plan, cut in said outer strip (7),

b) a so-called inner shaping component (4a) of diameter substantially equal to D is formed, having for example said radius of curvature R and intended to form said inner layer C_{I} or C_{I}′ (4, 4′) of said end wall (3, 3′, 3″) by:

b1) forming or supplying a first strip (60), typically plane, of thickness E_{IC} in said first material M_{IC}, or a so-called first blank (60′), of diameter at least equal to D, cut in said first strip (60),

b2) forming or supplying a so-called second strip (61), typically plane, of thickness E_{IS} and in said second material M_{IS}, or a so-called second blank (61′), of diameter at least equal to D, cut in said second strip (61),

b3) by assembling said first (60) and second (61) strips, or said first (60′) and second (61′) blanks, by said second assembly means (42), in such a way as to form a so-called inner strip (6) typically plane,

b4) by forming said inner strip (6) using a press, or a blank (6′) pre-cut in said inner strip (6), typically between a punch (80) and a matrix (81) of a forming press (8), in such a way as to form said inner shaping component (4a) having said radius of curvature R,

c) and, more preferably, said inner (4a) and outer (5a) shaping components are assembled using said first assembly means (30).

In this method, said first strip (60) or said first blank (60′), typically plane and of thickness E_{IC}, can be a first strip (62) or a first blank (62′) constituted of said first plane portions (620) of said first material M_{IC} assembled thanks to a so-called first butt weld (621) of substantially likewise thickness E_{IC}, in such a way as to be able to obtain an inner shaping component (4a) of great diameter typically greater than 2 m.

Said second strip (61) or said second blank (61′), typically plane and of thickness E_{IS} can be a second strip (63) or a second blank (63) constituted of said second plane portions (630) of said second material M_{IS} assembled thanks to a so-called second butt weld (631) of substantially likewise thickness E_{IS}, in such a way as to be able to obtain an inner shaping component (4a) of great diameter typically greater than 2 m.

In the case where the thickness E_{E} of the so-called outer layer E_{E} (5) is low to average, i.e. typically at most equal to 25 mm for a diameter D of 2 m, said outer shaping component (5a) can be obtained by direct forming of said outer strip (7) or of said blank (7′) of said outer strip (7) using said forming press.

On the other hand, in the case where the thickness E_{E} of the so-called outer layer E_{E} (5) is high, i.e. greater than a limit forming thickness E_{LE} typically around 25 mm for a diameter D of 2 m, said outer shaping component (5a) can be obtained by:

1) cutting of a plurality of N plane blanks (70) in said outer strip (7),

2) forming with the forming press of said plane blanks (70), in such a way as to form N elements of forming (51, 52, 53, 54),

3) welding of said N elements of forming (51, 52, 53, 54) in such a way as to form said outer shaping component (5a) with a so-called outer butt weld (55) of a thickness substantially equal to E_{E}.

Advantageously, said outer shaping component (5a) can be used as a matrix for the forming of said inner strip (6), in such a way as to form said inner shaping component (6a).

According to a mode of the method of the invention:

1) said inner shaping component (4a) is first formed,

2) after having formed said N elements of forming (51) of the so-called outer layer (5), said N elements of forming (51) are arranged in contact with said inner shaping component (4a), typically on said inner shaping component (4a), with the purpose of forming said outer butt weld (55),

3) said outer weld (55) of said N elements include a first step with formation of a first weld layer (550) constituting also said first assembly means (30).

In the method according to the invention, and when said total thickness E of said multilayer component (3″) forming said end wall (3), equal to E_{E}+E_{I}, is typically greater than 25 mm, the pair of thicknesses E_{E} and E_{IS} can be selected, at a constant total thickness E and typically by increasing the thickness E_{IS} to the detriment of the thickness E_{E}, in such a way as to, otherwise avoid, at least limit the number of heat treatments for relieving of internal stress or for annealing of said outer (5a) or inner (4a) shaping components, or of said end wall (3).

Indeed, on the one hand, the forming and deformations of materials required to form the vessels (1), and in particular the end walls (3) resulting in the forming of stresses in the material used, and on the other hand, the residual stresses present in a material can weaken its durability and its resistance to corrosion, in such a way that they must be eliminated, typically by a heat post-treatment, such as is provided in the construction standards of said vessels (1) or reactors (1′).

According to the invention, it is possible, thanks to a judicious choice of thicknesses E_{E} and E_{IS}, to avoid one or several heat post-treatments, while still maintaining constant said total thickness E, which is very advantageous from a practical and economical standpoint.

Another object of the invention is constituted by an element of forming (1″) of a chemical engineering device typically of a vessel (1), for example a reactor (1′), typically intended for the implementing of chemical reactions, forming a device for storing or transforming products able to resist pressure and vacuum.

It is characterised in that:

a) said element of forming (1″) has a curvature, with for example a radius of curvature R at least equal to 0.5 m,

b) said element of forming (1″) is a multilayer component (3″) of thickness E comprising:

b1) a so called inner layer C_{I} (4) providing a chemical inertness of said element of forming (1″) with regards to said products, and typically a resistance to corrosion with regards to said products,

b2) and a so-called outer layer C_{E} (5) of thickness E_{E} at least equal to the thickness E_{I} of said inner layer C_{I} (4), in such a way that the so-called outer layer C_{E} (5) provides the major part of the mechanical resistance of said element of forming (1″) of total thickness E equal to E_{E}+E_{I}, and its resistance to pressure,

c) said inner C_{I} (4) and outer C_{E} (5) layers are rigidly joined by said first assembly means (30), in such a way that said inner layer C_{I} (4) cannot separate from the so-called outer layer C_{E} (5) in particular when said element of forming (1″) is placed into a vacuum,

d) the so-called outer layer C_{E} (5) is an outer formed layer (5″) formed by forming of said outer strip (7) of basic material M_{B}, typically single-layer, having said thickness E_{E},

e) said inner layer C_{I} (4) as a multilayer inner layer C_{I}′ (4′) comprising at least one so-called internal layer C_{IC} (40) forming an inner coating of thickness E_{IC} in a said first material M_{IC} providing said resistance to corrosion, and a so-called external layer C_{IS} (41) of thickness E_{IS} in a said second material M_{IS} forming a support for said internal layer C_{IC}, said internal C_{IC} (40) and external C_{IS} (41) layers being rigidly joined by a said second assembly means (42), in such a way that said internal C_{IC} (41) and external C_{IS} (42) layers cannot separate from one another in particular when said chemical engineering device, typically said vessel (1), is placed in a vacuum,

f) said element of forming is devoid of butt welds of multilayer materials, in particular for said inner layer C_{I}.

### EXAMPLES

FIGS. 1a to 6f show different aspects of the invention or constitute examples of embodiments.

1) With regards to FIG. 1a, it shows a portion of a reactor (1, 1′) comprising a domed hemispheric end wall (3, 3′) of inner radius R, connected to a multilayer cylindrical side wall (2, 2′) with a typically low angle 8, the connection between said domed end wall (3, 3′) and said wall (2, 2′) being shown in this figure schematically.

This domed end wall (3, 3′) includes an inner layer C_{I} (4) of relatively low thickness E_{I}; this layer, which is continuous across all of its inner surface, provides the resistance to corrosion of the end wall. This inner layer C_{I} can be a single layer or be advantageously a multilayer inner layer C_{I}′ (4′), with examples of a multi-layer structure being shown in FIGS. 2c and 2d.

This domed end wall (3, 3′) comprises an outer layer C_{E} (5) forming a single-layer outer layer C_{E}′ (5′). In light of its relatively high thickness E_{E}, this outer layer (5, 5′) was formed by an assembly of 8 identical elements (50) thanks to so-called outer welds (55), such as is shown in FIG. 1b, each element (50) being an element (51) formed using a standard power press.

2) With regards to FIGS. 2a to 2d, they show the formation of the inner layer (4) by forming with the press (8) of a material in strips forming said inner multilayer strip (6), more specifically by forming of a circular blank (6′) cut in said inner strip (6). During this forming, a blank holder (82) compresses the edges of the blank (6′) against the edge of the matrix (81), while the axial force exerted by the punch (80) deforms the central wall of the blank in such a way that it hugs the inner surface of the matrix (81), typically without forming folds.

La FIG. 2b shows the inner shaping component (4a) obtained as such, and FIGS. 2c and 2d show two typical multilayer structures of it.

This inner shaping component (4a) is intended to then be assembled to the outer shaping component (5a) forming the so-called outer layer (5, 5′), using said first assembly means (30).

3) With regards to FIG. 3a, it shows an alternative of the mode described in FIG. 1b. In this mode, the outer shaping component (5a) includes four identical elements (52) surrounding a central element (53), with all of these elements being welded together thanks to said outer weld (55).

FIG. 3c shows the manufacture of the elements of forming (51) forming the elements (52) and (53) by forming of a plane blank (70) typically cut in said outer strip (7) of thickness E_{E}.

4) With regards to FIGS. 4a to 4f′, they schematise several alternatives of methods of manufacturing according to two main modes:

4-1) FIGS. 4b to 4f relate to the case wherein the width of the strip (6, 60, 61, 7) is sufficient to obtain shaping components (4a) and (5a) having the required dimensions.

The strip (6) is a multilayer strip C_{I} either of C_{IC}/C_{IS} structure according to FIG. 2c, or of C_{IC}/C_{II}/C_{IS} structure according to FIG. 2d.

The strip (60) is said first strip in material M_{IC}.

The strip (61) is said second strip in material M_{IS}.

The strip (7) is said outer strip in material M_{B}.

4-2) FIGS. 4b′ to 4f′ relate to the inverse case wherein the starting width of the strips (60), (61) and (7) are doubled, thanks to a longitudinal weld (621, 631, 72).

FIGS. 4b and 4b′ show respectively, the blanks (6′, 60′, 61′, 7′) cut in a simple strip (6, 60, 61, 7) and the blanks (62′, 63′, 7a′) cut in a strip doubled in width (62, 63, 7a).

FIGS. 4c and 4c′ show respectively the said first blanks (60′) and (62′) of material M_{IC} of relatively low thickness providing resistance to corrosion.

Likewise, FIGS. 4d and 4d′ show respectively the said seconds blanks (61′) and (63′) in material M_{IS} of greater relative thickness providing the function of support for the material M_{IC}.

The first blanks (60′, 62′) and said second blanks (61′, 63′) are then assembled thanks to an intermediary layer C_{II} (43).

In order to form the inner multilayer strip (6), said first (60) and second (61) strips can also be assembled, whether by roll bonding or by adding an intermediary layer (43).

Generally, and in light in particular of their low relative thickness, said first (60′, 62′) and second (61′, 63′) blanks are not formed in an isolated manner, but are assembled beforehand.

FIGS. 4e and 4e′ relate to outer blanks (7′) and (7a′) in single-layer material M_{B}, with the latter being a blank cut in a double strip, while the corresponding FIGS. 4f and 4f′ show shaping components (5a) or possible elements of forming (51) obtained by forming of the corresponding outer blanks (7′) and (7a′).

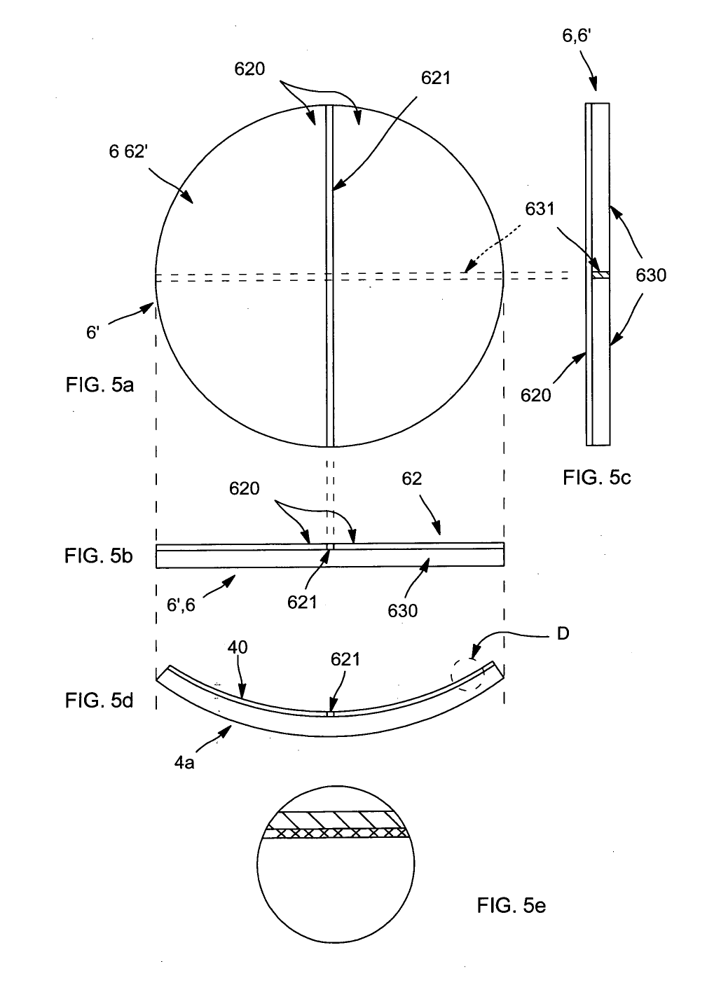

5) With regards to FIGS. 5a to 5e, they show the assembly of said first (60) and second (61) strips, in the case where said first strip (60) is a composed first strip (62), typically a double strip as shown in FIG. 4b′, and as well where said second strip (61) is a first composed strip (63), typically a double strip as shown in FIG. 4b′.

Advantageously, the longitudinal welds (621) and (631) are directed to 90°.

6) With regards to FIGS. 6a to 6f, they show two alternatives of said first assembly means (30) of inner (4) and outer (5) layers, in such a way that said end wall (3, 3′) or said reactor (1′) can resist a vacuum.

According to the alternative described in FIGS. 6a to 6c, and in the case where the so-called outer layer (5, 5′) is formed by assembly of a plurality of elements (50) of which the edges (500) are welded, this welding of the edges (500) is taken advantage of to also rigidly join the inner layer (4). According to the alternative described in the FIGS. 6d to 6f, and in the inverse case wherein the so-called outer layer (5) is constituted of a layer C_{E}′ comprising a single element (5c), bores (56) are formed forming blind holes across the entire thickness E_{E} of the so-called outer layer (5, 5c), and an outer weld (55) is formed rigidly joining said inner layer (4) to the so-called outer layer (5, 5c).

### Advantages of the Invention

The invention makes it possible to carry out, economically, a large variety of vessels or portions of vessels, and this, even in the case of parts or elements of large size, these vessels having to resist vacuum as well as resist pressure.

The invention makes it possible to limit the number of welds, to avoid in particular the welds considered to be “difficult” of prior art and in particular to avoid the butt welds of multilayer materials.

Furthermore, this method makes it possible to limit, and even eliminate, in particular with regards to the inner layer, the heat post-treatments required with the methods of prior art in order to comply with the requirements of construction codes, such as the CODAP or ASME codes. Indeed, the invention makes it possible to limit the thickness of the inner layer to a relatively low value in order to reduce the material costs in corrosion-resistant materials as well as to avoid any heat treatment for relieving internal stress which is moreover very expensive, for example when, according to the ASME code, the deformation of the neutral fibre exceeds 5%.

Finally, the invention is of a very general scope and is adapted to any type of chemical engineering device that requires resistance to pressure and vacuum.

### List of Marks

| | |
|---|---|
| Vessel | 1 |
| Reactor | 1′ |
| Element of forming | 1″ |
| Axial direction | 10 |
| Side wall | 2 |
| Multilayer side wall | 2′ |
| Inner layer of type 4 | 20 |
| Outer layer of type 5 | 21 |
| End wall | 3 |
| Domed end wall | 3′ |
| Multilayer component | 3″ |
| First assembly means 4 and 5 | 30 |
| Welded/brazed zone of layers 4 & 5 | 31 |
| Inner layer C_{I} of 3, 3′, 3″ | 4 |
| Multilayer inner layer C_{I}′ of 3, 3′, 3″ | 4′ |
| Inner shaping component | 4a |
| Internal layer C_{IC} | 40 |
| External layer C_{IS} | 41 |
| Second assembly means | 42 |
| Intermediary layer C_{II} | 43 |
| Brazing layer | 43′ |
| Outer layer C_{E} of 3, 3′ | 5 |
| Single-layer outer layer C_{E}′ | 5′ |
| Outer shaping component | 5a |
| Layer C_{E}′ comprising several elements 50 | 5b |
| Layer C_{E}′ comprising a single element | 5c |
| Elements of 5 | 50 |
| Edge to be welded of 50 | 500 |
| Elements of forming | 51 |
| Identical elements of 5 (N) | 52 |
| Central element of 5 | 53 |
| Peripheral elements of 5 (N − 1) | 54 |
| Outer weld | 55 |
| First layer forming 30 | 550 |
| Bore for the purposes of forming 30 | 56 |
| Multilayer inner strip | 6 |
| Blank cut in 6 | 6′ |
| First strip in material M_{IC} | 60 |
| First blank cut in the strip 60 | 60′ |
| Second strip in material M_{IS} | 61 |
| Second blank cut in the strip 61 | 61′ |
| First strip composed of portions | 62 |
| First blank composed of portions | 62′ |
| First portions | 620 |
| First weld of 620 | 621 |
| Second strip composed of portions | 63 |
| Second blank composed of portions | 63′ |
| Second portions | 630 |
| Second weld of 630 | 631 |
| Single-layer outer strip in material M_{B} | 7 |
| Outer blank cut in 7 | 7′ |
| Outer strip composed of portions | 7a |
| Outer blank cut in 7a | 7a′ |
| Blanks cut in 7 for 50 | 70 |
| Portions of the strip 7a | 71 |
| Weld of the strip 7a | 72 |
| Forming press | 8 |
| Forming punch | 80 |
| Forming matrix | 81 |
| Blank holder | 82 |

1. Vessel (1), typically a reactor (1′) intended for the implementing of a nuclear or chemical reactions, forming a device for storing or transforming products able to resist pressure and vacuum, said vessel (1) comprising a side wall (2) typically cylindrical of diameter D at least equal to 1 m, and an end wall (3), typically of likewise diameter D, assembled to said side wall (2), said side wall (2) and said end wall (3) being typically of metal, characterised in that:
a) said end wall (3) of said vessel (1) is a domed end wall (3′),
b) said domed end wall (3′) forms a multilayer component (3″) of thickness E comprising:
b1) a so called inner layer C, (4) providing a chemical inertness of said domed end wall (3′) with regards to said products, and typically a resistance to corrosion with regards to said products,
b2) and a so-called outer layer C_{E} (5) of thickness E_{E} at least equal to the thickness E, of said inner layer C_{I} (4), in such a way that the so-called outer layer C_{E} (5) provides the major part of the mechanical resistance of said multilayer component (3″) of total thickness E equal to E_{E}+E_{I}, and its resistance to pressure,
c) said inner C_{I} (4) and outer C_{E} (5) layers are rigidly joined by a so-called first assembly means (30), in such a way that said inner layer C_{I} (4) cannot separate from the so-called outer layer C_{E} (5) in particular when said vessel (1) is placed in a vacuum,
d) said inner layer C_{I} (4) is a multilayer inner layer C_{I}′ (4′) formed of a multilayer material comprising at least one so-called internal layer C_{IC} (40) forming an inner coating of thickness EIC in a so-called first material MIC able to provide said resistance to corrosion, and a so-called external layer C_{IS} (41) of thickness E_{IS} in a so-called second material MIS forming a support for said internal layer C_{IC}, said internal C_{IC} (40) and external C_{I}S (41) layers being rigidly joined by a so-called second assembly means (42), in such a way that said internal C_{IC} (40) and external C_{IS} (41) layers cannot separate from one another in particular when said vessel (1) is placed in a vacuum,
e) said vessel is devoid of butt welds of multilayer materials, in particular for said inner layer C_{I}.

2. Vessel set forth in claim 1 wherein the so-called outer layer C_{E} (5, 5′) is an outer layer (5b) comprising a plurality of N elements (50) of thickness E_{E} rigidly joined together by a so-called outer butt weld (55), with N ranging typically from 2 to 16.

3. Vessel set forth in claim 2 wherein said plurality of N elements (50) is formed of N identical elements (52) rigidly joined together by said outer weld (55).

4. Vessel set forth in claim 2 wherein said plurality of N elements (50) comprises a central element (53) and N-1 identical peripheral elements (54).

5-6. (canceled)

7. Vessel set forth in claim 1 wherein the so-called outer layer C_{E} (5, 5′) is an outer layer (5c) comprising a single element forming a single-layer shaping component of thickness E_{E}.

8. Vessel according to claim 1 wherein the ratio of thicknesses E_{E}/E_{I} ranges from 1 to 20 and more preferably from 2 to 10.

9. Vessel according to claim 1 wherein said thickness EE ranges from 15 mm to 100 mm, and said thickness E_{I} ranges from 4 mm to 15 mm.

10. (canceled)

11. Vessel according to claim 1 wherein said internal layer C_{IC} (40) has a thickness E_{IC} from 0.4 mm to 4 mm and a ratio of thicknesses E_{IS}/E_{IC} from 2 to 10.

12. (canceled)

13. Vessel according to claim 1 wherein said first material M_{IC} forming said internal layer C_{IC} (40) is selected from the group consisting of tantalum or tantalum alloys, titanium, titanium alloys, zirconium, zirconium alloys, nickel-base alloys and stainless steels, the so-called outer layer C_{E} (5, 5′) is formed using a so-called basic material M_{B}, is a strip of thickness substantially equal to E_{E}, said basic material M_{B} being selected a steel or a stainless steel, and said second material M_{IS} forming said external layer (41) is a steel or stainless steel.

14-15. (canceled)

16. Vessel according to claim 12 wherein said second material M_{IS} forming said external layer (41) and said basic material M_{B} forming the so-called outer layer (5, 5′) are identical.

17. Vessel according to claim 1 wherein said multilayer inner layer C_{I}′ (4′) comprises an intermediary layer C_{II} (43) rigidly joining said internal layer C_{IC} (40) to said external layer C_{IS} (41), said multilayer inner layer C_{I}′ (4′) forming as such a multilayer material shown symbolically by C_{IC}/C_{II}/C_{IS}, said internal layer C_{IC} (40) being intended to be in contact with said products, said external layer C_{IS} (41) being rigidly joined to the so-called outer layer C_{E} (5) thanks to said first assembly means (30).

18. (canceled)

19. Vessel according to claim 1 wherein said internal C_{IC} (40) and external C_{I}S (41) layers are co-laminated layers, in such a way as to form said second assembly means (42) or are plate, typically by explosion, in such a way as to form said second assembly means (42).

20. (canceled)

21. Vessel according to claim 1 wherein said inner C_{I} (4, 4′) and outer C_{E} (5, 5′) layers are assembled together by welding or by brazing, in such a way as to form said first assembly means (30).

22. Vessel according to claim 1 wherein said side wall (2) is a multilayer side wall (2′) comprising:
a) a so-called inner wall layer C_{IP} (20) similar to said inner layer C_{I} (4,4′) comprising said internal layer C_{IC} (40) in said first material M_{IC} providing said resistance to corrosion, and said external layer C_{IS} (41) in said second material M_{IS} forming a support for said internal layer C_{IC} (40), and
b) a so-called outer wall layer C_{EP} (21) similar to the so-called outer layer C_{E} (5, 5′) in said basic material M_{B}, of thickness at least equal to the thickness of said inner wall layer C_{IP} (20), in such a way that said outer wall layer C_{EP} (21) provides the major part of the mechanical resistance of said side wall (2, 2′) and its resistance to pressure.

23. Vessel according to claim 1 wherein said end wall (3, 3′, 3″) and said side wall (2, 2′) are connected together by making an angle α of less than 60°.

24. Vessel according to claim 1 wherein said domed end wall (3′) is a tapered end wall or an end wall forming a spherical cover of radius of curvature R at least equal to 0.5 D.

25. Vessel according to claim 1 wherein the so-called outer layer C_{E} (5) is an outer layer C_{E}′ (5′) formed of a single-layer material having said thickness E_{E}.

26. Vessel according to claim 1 wherein the so-called outer layer C_{E} (5) is an outer layer C_{E}′ formed of a multilayer material having said thickness E_{E}.

27. Method of manufacturing an end wall (3, 3′, 3″) of said vessel (1) according to claim 1 wherein:
a) a so-called outer shaping component (5a) is formed of diameter substantially equal to D, having for example said radius of curvature R, and intended to form the so-called outer layer C_{E} (5, 5′) of said end wall (3, 3′, 3″), using a forming press (8) using a so-called outer strip (7), typically plane, of said basic material MB and of thickness E_{E}, or of a blank (7′), typically plan, cut in said outer strip (7),
b) a so-called inner shaping component (4a) is formed of diameter substantially equal to D, having for example said radius of curvature R and intended to form said inner layer C_{I}or C_{I}′ (4, 4′) of said end wall (3, 3′, 3″) by:
b1) forming or supplying a first strip (60), typically plane, of thickness E_{IC} in said first material M_{IC}, or a so-called first blank (60′), of diameter at least equal to D, cut in said first strip (60),
b2) forming or supplying a so-called second strip (61), typically plane, of thickness E_{IS} and in said second material M_{IS}, or a so-called second blank (61′), of diameter at least equal to D, cut in said second strip (61),
b3) by assembling said first (60) and second (61) strips, or said first (60′) and second (61′) blanks, by said second assembly means (42), in such a way as to form a so-called inner strip (6) typically plane,
b4) by forming said inner strip (6) using a press, or a blank (6′) pre-cut in said inner strip (6), typically between a punch (80) and a matrix (81) of a forming press (8), in such a way as to form said inner shaping component (4a) having said radius of curvature R,
c) and, more preferably, said inner (4a) and outer (5a) shaping components are assembled using said first assembly means (30).

28-34. (canceled)

35. Element of forming (1″) of a chemical engineering device typically of a vessel (1), for example of a reactor (1′), typically intended for implementing chemical reactions, forming a device for storing or transforming products able to resist pressure and vacuum characterised in that:
a) said element of forming (1″) has a curvature, with for example a radius of curvature R at least equal to 0.5 m,
b) said element of forming (1″) is a multilayer component (3″) of thickness E comprising:
b1) a so called inner layer C_{I} (4) providing a chemical inertness of said element of forming (1″) with regards to said products, and typically a resistance to corrosion with regards to said products,
b2) and a so-called outer layer C_{E} (5) of thickness E_{E} at least equal to the thickness E_{I} of said inner layer C_{I} (4), in such a way that the so-called outer layer C_{E} (5) provides the major part of the mechanical resistance of said element of forming (1″) of total thickness E equal to E_{E}+E_{I}, and its resistance to pressure,
c) said inner C_{I} (4) and outer C_{E} (5) layers are rigidly joined by said first assembly means (30), in such a way that said inner layer C_{I} (4) cannot separate from the so-called outer layer C_{E} (5) in particular when said element of forming (1″) is placed in a vacuum,
d) the so-called outer layer C_{E} (5) is a formed outer layer (5″) formed by forming of said outer strip (7) in basic material M_{B}, typically single-layer, having said thickness E_{E},
e) said inner layer C_{I} (4) is a multilayer inner layer C_{I}′ (4′) comprising at least one so-called internal layer C_{IC} (40) forming an inner coating of thickness E_{IC} in a so-called first material MIC providing said resistance to corrosion, and a so-called external layer C_{IS} (41) of thickness E_{IS} in a so-called second material M_{IS} forming a support for said internal layer C_{IC}, said internal C_{IC} (40) and external C_{IC} (41) layers being rigidly joined by a so-called second assembly means (42), in such a way that said internal C_{IC} (41) and external C_{IS} (42) layers cannot separate from one another in particular when said chemical engineering device, typically said vessel (1), is placed in a vacuum,
f) said element of forming is devoid of butt welds of multilayer materials, in particular for said inner layer C_{I}.
